(19) United States
(12) Patent Application Publication
(10) Pub. No.: US 2006/0282500 A1
(43) Pub. Date: Dec. 14, 2006

(54) Information management method using a managing symbol and information management server

(76) Inventors: Yutaka Kiuchi, Hiratsuka-shi (JP); Kohshiro Inomata, Hadano-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(21) Appl. No.: 11/448,681

(22) Filed: Jun. 8, 2006

(30) Foreign Application Priority Data
Jun. 13, 2005 (JP) 2005-172472

(51) Int. Cl. G06F 15/16

(52) U.S. Cl. 709/203

(57) ABSTRACT

An information management method using a managing symbol and an information management server for managing a plurality of electronic contents and automatically performing an action according to each content. Association between a bit string assigned to each content and the storage address of the content is stored, and a managing symbol representing the bit string is published. The association is referred to specify the content correspondent to the bit string. The action to be performed on the content is decided by referring to an action type selected beforehand.

### CROSS-REFERENCE TO RELATED APPLICATION

This application claims priority under 35 USC 119 from Japanese Patent Application No. 2005-172472, the disclosure of which is incorporated by reference herein.

### BACKGROUND OF THE INVENTION

1. Technical Field

This invention relates to a technique and methods for sending and receiving electronic content between a server and a client connected to a network using a managing symbol.

22. Related Arts

Digitalization of input and output devices has become more common with such technical advancements as increase in computer processing speed and storage medium memory capacity. Data formats of digital information being handled have also increased in variety. For example, images (photographs), sound and video that were handled as analog information in the past are now increasingly being handled as digital data.

Also, with the advancement in communications technologies, network environment is being established allowing for easy sending and receiving of such digital data. Furthermore, mobile phones and other mobile devices have come to be equipped with Internet connecting functions, thereby increasing the opportunity for the user to gain access to digital information. Users can now exchange information free from time and geographical constraints.

However, it is also true that many people still find operation of information devices difficult. The so-called “digital divide” between those who have the ability to handle digital information and those who don't is becoming a serious social problem. Many middle-aged and elderly people especially feel uncomfortable using keyboards to operate information devices. Even for someone skilled in handling digital information, inputting long text using easy-to-carry small mobile devices, such as mobile phones, is difficult and time consuming.

Japanese Laid-Open Patent No. 2003-233546 suggests a method for inputting an URL (Uniform Resource Locator), the global address on the World Wide Web, by taking an image of a two-dimensional code representing the URL printed on a flat surface using a camera function equipped on a mobile phone.

A wide variety of digital information surrounds us recently, and in many cases we are required to handle a large volume of digital data. In general, text data handling text and numerical information only require several bytes, where as still image data and audio data require several kilobytes to several megabytes. As for video data, several gigabytes are sometimes required.

Two-dimensional codes, as compared to conventional barcodes, allow for digital data to be displayed at a higher density. However, in the above-mentioned prior art where information is expressed using a mark placed on a flat surface, there is a limit in handling such large-volume data as image and audio data.

It is apparent that the approach to increase the density of the two-dimensional code by making the size of the cells very small has its constraints. Therefore, currently existing two-dimensional codes are able to handle only a limited type of information such as text data.

Along with the increase in variety of digital information around us, we are seeing an improvement in network environment, allowing for users to use electronic contents in many different ways. For example, users can browse images and other contents on a network using a mobile device, anytime, anywhere. Users can also transfer data to share contents among a plurality of mobile devices. Electronic contents consist of different types of data, and each content may be appropriately operated according to its data type or be customized for each user.

With the suggested method in the above-mentioned prior art, the URL is decoded using the image of the two-dimensional code so that the users can access to the information located in the Internet without having to use the keyboard. However, this method merely substitutes the inputting of the URL, and therefore does not suggest any ways for automatic operation of a content according to its type or customization.

Currently, in order to change the operation for each content, the user needs to specify the operation each time. Thus, there is need for a method to automatically perform operations appropriate for each content in order to reduce the burden upon the users.

### SUMMARY OF THE INVENTION

The present invention has been made in view of the above circumstances and with an aspect to provide an information management method for transferring electronic data between a server and a client on a network, using a managing symbol. Furthermore, the present invention has an aspect to provide an information management method for automatically performing an appropriate operation for electronic contents in a variety of data formats.

An information management method according to an aspect of the present invention comprises the following steps: storing the electronic content in a storage area accessible from the server; storing an association between a bit string assigned to each electronic content and the storage address of the electronic content in a storage area accessible from the server; publishing a managing symbol representing the bit string in the server; obtaining the bit string decoded based upon the managing symbol captured by a client terminal; and specifying the electronic content correspondent to the decoded bit string by referring to the association with the electronic content.

The electronic content according to the present invention includes a variety of digital information that consists of such electronic data as still image information, video information, audio information, text information and such.

Still image information may be image data in such data formats as jpeg, bitmap and the like. Video information may be video data in such data formats as mpeg, wmv, avi and such. Audio information may be music data in such data formats as mp3, wav and such. Text information may be text data of any kind of data formats such as address information like URLs, information on a name card and personal memos. Text data is represented using character codes such as the EUC code, Shift JIS code, Unicode and such.

Electronic content according to the present invention may also include information created using application software such as word processing software, spreadsheet software, scheduling software and such. It may also include authentication information such as an ID or a password, encryption information that is an encrypted bit string, and execution programs.

The managing symbol according to the present invention is a transformation of an image pattern on a flat surface that represents a bit string. In the present invention, an image of the managing symbol is taken using an image capturing function of a client terminal, and then analyzed to decode the bit string.

The client terminal then accesses a server via a network. The address of the server is stored within the client terminal beforehand. The accessed server specifies the electronic content correspondent to the bit string and performs an operation on the content. Thus, the content may be accessed using the client terminal via a network.

The managing symbol is published in association with the storage address of the electronic content so that the content may be specified later. The association between the managing symbol and the storage address is stored in a storage area accessible from the server. The storage area may be within the server or a storage area managed by another server on the network.

The storage address of the content consists of an URL, a file path indicating a folder within the server or the like. More specifically, the storage address consists of a server name, a port number, a folder name, a file name and such. The storage area storing the content may be within the server or an area managed by another server on the network.

The server according to the present invention preferably has constant connection to a network, and performs a predetermined operation upon request from a client terminal equipped with an image capturing function.

The server may be a single server machine performing all of the necessary functions, or a plurality of server machines with the functions divided among them.

Another aspect of the present invention relates to the information management method as mentioned above, further characterized by the following: the storage address of the electronic content is recorded in a database stored in a storage area accessible from the server; the bit string assigned to each electronic content corresponds to a record number of the database; the bit string correspondent to a record number includes redundant data; the managing symbol is a two-dimensional code representing the bit string by displaying a data mark within each of a plurality of cells placed on a flat surface; and the bit string including redundant data is represented as a two-dimensional code using a rule that is not made public.

In this aspect of the present invention, a data set of bit strings, address information or the like related to electronic contents is centrally managed by the server using a database in table format.

By using a database, it is possible to handle a large amount of electronic contents, and also to process simultaneous accesses from a number of users. The access dates and other log information may also be registered in the database for an even more accurate management of the electronic contents.

It is preferable to describe the database in a versatile language such as the SQL (Structured Query Language) language, using such generally used applications as MySQL, PostgreSQL, and Oracle.

Each electronic content is allocated to a record and also corresponds to a managing symbol. Storage address of the content is allocated to a field (storage address field). Therefore it is possible to specify the content from the managing symbol.

It is preferred to manage the records by giving them serial record numbers so that effective and speedy searching is possible even with a vast number of records. The record numbers are preferred to be represented by a bit string of binary numbers.

A bit string is assigned to correspond to each record number. The managing symbol represents the bit string and is associated with a record. When the managing symbol is read, the record number is decoded from the bit string. The bit string according to the present invention is a minimum unit of information handled by a computer, and is a combination of 1 and 0 in a binary number string.

It is preferable that the bit string includes redundant data, and is represented as a managing symbol using a rule that is not made public so as to prevent unwanted access from a third person. The two-dimensional code representing the managing symbol may have an original display rule, or the bit string may be encrypted.

For example, the record number consisting of a binary number string may have any number of extra digits added anywhere within the string, and be encrypted using the common key encryption system such as DES (Data Encryption Standard), Triple DES, AES (Advanced Encryption Standard) and the like.

The managing symbol according the present invention is preferably represented by a binary code. Binary code can contain a larger volume of information compared to conventional barcodes.

The binary code is generally composed of a plurality of cells arranged in a lattice pattern and positioning symbols. Data marks that mark the cells are used to express a bit string. For example, presence and absence of data marks corresponds to 1 and 0 and is shown accordingly. Data marks colored in three elementary color components (CMY or RGB) may be used to generate a color two-dimensional code.

According to this aspect of the present invention, image data of the managing symbol is obtained using an optical image-capturing device. The captured image data is then analyzed using a computer to find out how each cell is displayed to decode the original bit string.

The server obtains the record number correspondent to the decoded bit string so that the record number remains undisclosed to a third person to prevent unauthorized access.

The image data is preferably sent from a client terminal to the server to be analyzed therein so that the client terminal does not need to be installed with such application. It is also efficient since the processing power of the server is usually higher than that of a client terminal.

Yet another aspect of the present invention relates to the information management method as mentioned above, further characterized by the following: the redundant data included in the bit string is an error-correcting code; coding and decoding using the error-correcting code are performed in the server; and the rule for displaying the cells of the two-dimensional code is not made public.

An example of redundant data added to the bit string is an error-correcting code. By adding an error-correcting code, the original bit string can be decoded correctly even when an error occurs within the data when reading the managing symbol. Error-correcting codes serve for both error correcting and security enhancement, and allow for a large number of contents to be handled with a small number of bits. Examples of error-correcting code are the Reed Solomon code, the BCH (Bose-Chaudhuri-Hocquenghem) code and the extended BCH code.

It is preferable to use such a two-dimensional code the display rules of which are not known to a third person. The bit string before the addition of redundant data can be easily known by a third person when QR codes and other codes whose specifications are open to the public are used, whereas using codes with original display rules prevents a third person from figuring it out.

Display rule according to the present invention is a rule that specifies which bit within the bit string corresponds to which cell, and how each value is displayed. Most previously known two-dimensional codes consist of a plurality of cells arranged in a lattice pattern each being numbered, and the presence and absence of data marks corresponds to 1 and 0 and is shown accordingly. In the present invention, the relationship between the value of the bit string and the way in which the cells are displayed are not made public.

It is preferable to change the display rule for each two-dimensional code that is published by preparing a plurality of display rules to select from upon publication. The selected display rule is embedded in an area other than that representing the bit string, and is referred to upon restoration of the bit string. The display rule is managed within the server and is not made public.

When an error-correcting code is implemented, the value of each bit and the display of each cell (presence and absence of a data mark) correspond one to one for conversion. In case of a color two-dimensional code, the value of each bit corresponds to the presence and absence of data mark of each color component. In this way, a read error of the cell corresponds to an error in the bit string.

It is preferable to convert either the type of cell display or the correspondence between the bit position and the cell number, or the combination of both for enhancing security. The conversion may be performed on the bit string, by switching the bit positions or by inversing the bit values, or both.

The bit string is preferably displayed in a cell in such a way that is appropriate to correct the bias of errors in the two-dimensional code. In other words, the relationship between the bit string and the cell is preferably constructed to include a plurality of error bits in an error-correcting symbol. It is also preferable to maintain this relationship when converting the display rules.

More specifically, since errors generally tend to concentrate in a particular area, it is recommended to construct the bit string by having cells placed close to each other corresponding, as a unit, to a symbol. In color two-dimensional codes, errors tend to concentrate in a particular color component, so it is recommended to have the cells of the same color component corresponding, as a unit, to a symbol.

Yet another aspect of the present invention relates to the information management method as described above, further characterized by the following: the database includes a control field for recording information to control the period or number of use of the record number; the usage of the record number that has exceeded its predetermined period or number limit of use is suspended; and the suspension period of the record number is managed so as to resume usage of the record number after a predetermined time has lapsed.

According to this aspect of the present invention, a record that was used before is freed and reused when a new managing symbol is published. In this way, the records are used effectively so that a larger number of contents may be constantly registered by users. Another advantage is that a less number of records will be sufficed so that the display size of the managing symbols can be kept relatively small.

In reusing records, access from a user that used the same record in the past must be avoided. Therefore, it is preferable that a record that is used once is suspended from being used again for a certain period of time.

The level of security and the cycle or usage generally differs depending upon the type of the content. Therefore it is preferable to prepare a plurality of suspension periods accordingly.

Period and number of use of the contents may be managed in the server by including a control field in the database. The provider of the electronic content may set a period and number limit that the content can be used according to its objective.

Another aspect of the present invention relates to an information management method for managing electronic content within a server connected to a network, comprising the steps of: storing the electronic content in a storage area accessible from the server; setting an operation to the electronic content by selecting from a plurality of operational modes provided for each digital content type; publishing a managing symbol associated with the electronic content in the server; specifying the electronic content associated with the managing symbol captured by a client terminal; deciding the operation to be performed to the electronic content upon reference to the set operation; and performing the operation via a program stored in the server.

According to this aspect of the present invention, an action type defines the action to be performed on the contents. The user selects from a prepared set of action types to set an action type to the content. There may also be default action type to be selected automatically when the user does not make a selection.

The present invention is intended to handle various types of digital information, and therefore it is preferable to prepare one or more action types for each type of information.

In order to realize a variety of actions, the server may access different machines on the network according to the action type.

The action on the content may be performed on a client terminal by sending the content from the server to the client terminal. When the content is an image data or a video data, for example, the image may be displayed or the video may be played on the display of the client terminal. When the content is a text data such as an URL, the client terminal may access the URL to obtain the web page to be displayed on the client terminal. When the content is personal information such as address, name and telephone number, it may be added to the address book of the client terminal.

When the content is created by a particular application, the action is performed accordingly.

An action to be performed on a content that consist of a plurality of electronic data may be predetermined. For example, when the content consists of a plurality of image data, each image data may be album displayed one by one on the client terminal.

The content may also include different types of electronic data, and different actions may be set to each type of-data. When the content includes music data and text data describing the music data, for example, downloading of the music data and displaying of the text data may be performed simultaneously.

The action on the content may be performed within the server without being sent to the client terminal. For example, when the server is managing a personal page (or so-called “My Page”) on the network, an URL may be added to a bookmark list on the personal page. This action may be performed in combination with another action, such as sending the content (URL, in this case) to the client terminal, so that the web page of the added URL may be also displayed on the client terminal.

The action on the content may be performed by sending the content to another server. For example, an URL may be sent and added to a bookmark list on a personal page that is managed by a different server. Image data, music data and other electronic data may be sent to another server to be stored in its storage area. Such authentication information as an ID or password may sent to a website managed by another server and be used to access the site.

The program on the server performs an action according to the action type. The action according to the present information is performed on the content to bring about change on its electronic data. Electronic data is, for example, transferred, copied, deleted, or converted. Information necessary in performing the action, such as the address to be transferred to, or the conversion method, is obtained by the program that performs the action. For example, when the content is address information such as an URL, the program on the server decides according to the action type whether to send it to the client terminal or to another server managing the personal page. When the content is a music data, the program first refers to another information defining authorization of distribution, and then decides to send it or not send it to the client terminal.

An action type may include a plurality of action types. In such a case, the program on the server performs the action types in combination. For example, when displaying an image data on the client terminal, it sends the image data to the client terminal and also converts its image size or position in a certain manner.

When the content is used on the client terminal or another server, it is preferred that the server sends the content together with its action type, so that the client terminal or another server can perform the action upon reference to its action type. It is preferred that not only the server but also the client terminal holds a table regarding the action types to obtain necessary information for performing the action.

Another aspect of the present invention relates to the information management method as mentioned above, further characterized by the following: the association between the managing symbol and the electronic content is recorded in a database stored in a storage area accessible from the server; the database includes an operation type field for setting an operation to the electronic content; and the operation performed on the electronic content is decided upon reference to the operation type field.

According to this aspect of the present invention, the association between the managing symbol and the action type is recorded in a database stored in a storage area accessible from the server. The action type is stored in a field (action type field) of the database upon registration of the content. When the managing symbol is decoded to specify the record of the content, the action type is obtained referring to the action type field.

By managing the action types on the server, it is possible to change an action correspondent to a content even after publication of the managing symbol using a predetermined program or other means.

For example, when the content is a music data, image data or video data to be distributed to a client terminal during a certain period of time, the action type may be changed after the certain period of time has lapsed to stop distribution of content and to display a text informing the client that the distribution period has ended.

Yet another aspect of the present invention relates to the information management method as mentioned described above, further characterized by the following: the electronic content consists of at least one image data; the server obtains information regarding a display screen of a client terminal; the image data is converted according to the information regarding the display screen; and the converted image data is sent to the client terminal from the server and then displayed on the display screen of the client terminal.

In another aspect of the present invention, a client terminal such as a mobile device may receive a plurality of image data and display the received images on its display screen in an album display for the user to view the displayed images. The plurality of images may be first displayed as thumbnail images and then when the user selects an image, the selected image is shown as an enlarged image. The enlarged images of the plurality of images may also be shown sequentially at certain time intervals like a slideshow, or upon instruction by the user.

The server may, when sending the image data to a mobile device, process the images to fit the mobile device. For example, the server may resize the image data according to the display pixels of the mobile device, or convert the number of colors of the image data according to the number of colors of the mobile device display.

Images optimized for mobile devices are generally smaller in size than images captured by a digital camera and such devices. It is preferable to convert the images in the server before sending them to reduce the load on the network, and so that the mobile device is able to receive and display the images quickly.

When displaying a plurality of images as thumbnail images, the reduced images are generated in the server and then sent to the mobile device. The network load can be reduced by sending the enlarged image only upon selection of the thumbnail image.

Yet another aspect of the present invention relates to the information management method as mentioned above, further characterized by the following: a user information table recording information regarding a user that uses the client terminal is stored in a storage area accessible from the server; the operation to be performed on each electronic content is set based upon the operation type selected by the user and recorded in the user information table; the user using the client terminal is specified by the server obtaining information from the client terminal; and the operation to be performed on the electronic content is decided upon reference to the user information table.

An user information table according to this aspect of the present invention is a table that records information-to identify the users and information set for each individual user. Examples of the user identifying information include user ID, user password and unique identifier of a client terminal. Information set for each individual user includes action set by a user, storage address of personal storage area, and authentication information for the personal storage area.

The server accessed by a client terminal receives such information as user ID, user password and unique identifier of client terminal, and identifies the user. Using the unique identifier of the client terminal is advantageous in that the user does not need to input his/her ID and password every time.

It is preferable that the action to be performed on the contents is set in advance in the user information table according to the type of digital information of the content. In this way, the type of digital information is determined upon reading of the managing symbol, and then the user information table is referred to in order to decide the action.

The type of digital information of each content may be recorded in the database retained in the server to be referred to. It is also possible to obtain the type of digital information, or the data format from the extension of the content file. It is also possible to obtain the data format by analyzing the header information of the content file, for example. When the content is a text data, it is possible to specify the type of information by analyzing the text.

Yet another aspect of the present invention relates to the information management method as mentioned above, further characterized by the following: a user information table recording information regarding a user that uses the client terminal is stored in a storage area accessible from the server; the user information table records information for specifying an address of a personal storage area of the user; the user using the client terminal is specified by the server obtaining information from the client terminal; and the electronic content stored in the storage area is stored in the personal storage area of the specified user.

A personal storage area is generally a storage area within the server for exclusive use by each user. The personal storage area may exist anywhere on the network, and not necessarily in the server that decides the action on the contents.

The personal storage area generally has a user authentication system, and the user needs to input his/her ID and password to access. When the storage area is managed by a different server, the ID and password may be set beforehand in the user information table so that they are input automatically.

The user can store a content in his/her personal storage area by reading the managing symbol published by the provider of the content. The content may also be received by the client terminal at the same time. When the content is an URL, it is bookmarked in the personal web page prepared in the storage area. The web page may also be displayed at that time on the client terminal.

Another aspect of the present invention relates to an information management server that manages sending and receiving of electronic content via the server among a plurality of client terminals capable of being connected to a network, wherein at least one of the client terminals is a mobile device equipped with an image capturing function, that comprises the following: a content receiving means for receiving an electronic content from a client terminal; an instructing means for instructing the received electronic content to be stored in a storage area accessible from the server; a managing symbol publishing means for publishing a managing symbol; an information obtaining means for obtaining, after the managing symbol is output, information embedded in the management symbol that is obtained based upon an image taken by a mobile device equipped with an image capturing function; and a content sending means for sending the stored electronic content to the client terminal.

The content is stored in a storage area accessible by the server upon instruction by an instruction means. The storage area may be within the server or may be managed by another server to be accessed via a network.

The managing symbol published by the managing symbol publishing means is output via an output means. The output means may be a printing device connected to the server or the client terminal. In that case, the managing symbol is printed out on a sheet of paper. The output means may also be a display equipped on the client terminal, and in that case, the managing symbol is output by being displayed on the display.

The managing symbol output by the output means is then obtained by an image capturing means equipped on a mobile device. The information embedded in the managing symbol is then decoded based upon the obtained image.

The managing symbol decoding means is preferably implemented on the server, or it may also be implemented on the mobile device with an application to analyze the image and decode the embedded information.

The information managing server according to the above aspect of the present invention may further comprise the following: a recording means for recording an association between the managing symbol and the electronic content; a content specifying means for specifying the electronic content upon reference to the association based upon the information obtained by the information obtaining means; an operation deciding means for deciding an operation according to the type of digital information consisting the specified electronic content; and a content processing means for processing the electronic content according to the operation decided by the operation deciding means.

With the above construction, it is possible to manage a plurality of contents consisting of a variety of digital data with operation performed on each content accordingly with its digital data type.

The information managing server according to the above aspect of the present invention may also comprise: a recording means for recording a association between the managing symbol and the electronic content; an electronic mail receiving means for receiving an image of the managing symbol sent using a electronic mail function of the mobile device; a managing symbol decoding means for decoding information embedded in the managing symbol from the received image; a content specifying means for specifying the content upon reference to the association with the managing symbol based upon the information obtained by the information obtaining means; and an electronic mail sending means for sending an electronic mail to the mobile device, the electronic mail including either the content specified by the content specifying means or an storage address of the content.

With the above construction, it is possible to exchange information between the server and a mobile device by sending and receiving of e-mail.

It is preferable that the mobile device comprises an electronic mail sending means for sending electronic mail to the server, and an electronic mail receiving means for receiving electronic mail sent from the server in return. The mobile device preferably further comprises a content obtaining means for obtaining the content based upon the received electronic mail.

Sending and receiving of managing symbols and contents are preferably performed using a mail function equipped in the mobile device, so that it is not necessary to prepare a plurality of applications to conform to specifications differing among mobile telecommunications companies. Moreover, mail function of a mobile device, such as a mobile phone, is widely used today, and users do not need to learn a new way of usage or install new settings.

Sending and receiving of image data of managing symbols and contents can be performed using a function to attach a file to the e-mail generally equipped in most mailing software of mobile devices. The content is preferably attached to the e-mail as a file.

When the content is a text data, the text data may be directly inserted in the e-mail instead of being attached as a file.

It is also possible to include the storage address of the content in the e-mail instead of attaching the actual content. In that case, the user can specify the storage address to download the content. The user can first refer to the tag upon receiving the e-mail before deciding whether to download the content or not.

The information managing server according to the above aspect of the present invention may also comprise: a recording means for recording an association between the managing symbol and the electronic content; a managing symbol sending means that sends the managing symbol published by the managing symbol publishing means, and displays the managing symbol on the display of the client terminal; a content specifying means for specifying the content upon reference to the association with the managing symbol based upon the information obtained by the information obtaining means; and a content sending means for sending the specified content to the mobile device.

With the above construction, it is possible to send the content, via the server, from the client terminal storing the content to another client terminal, a mobile device, in this case.

The client terminal preferably is equipped with an output means, such as a display, for example, to output the managing symbol sent from the managing symbol sending means.

The information managing server according to the above aspect of the present invention may also comprise: an access identifying means for identifying an access from the client terminal; a recording means for recording an association between the managing symbol and the access; a managing symbol sending means that sends the managing symbol published by the managing symbol publishing means, and displays the managing symbol on the display of the client terminal; an access specifying means for specifying the access upon reference to the association with the managing symbol based upon the information obtained by the information obtaining means; and a content sending means for sending the specified content to the client terminal that accessed the server.

With the above construction, it is possible to transfer the content, via the server, from the client terminal storing the content to another client terminal.

The client terminal accessing the server may be a personal computer or a mobile device. In the present aspect of the invention, access from such client terminals are identified and recorded in the server in association with the managing symbol. In this way, the client terminal that has accessed the server can be specified, and the content is sent to the specified client terminal.

A session information, such as a cookie, recorded when the client terminal accesses the server is used to identify the access. The session can be secured by associating the cookie to the managing server.

Address or unique number of the client terminal, date and time of the access and other information may also be used as client terminal specifying information for identifying the access.

According to the present aspect of the invention, the content can be transferred from the mobile device to the personal computer via the server by recording the access from the personal computer. The content can be transferred from the personal computer to the mobile device by recording the access from the personal computer.

By recording access from both the mobile device and the personal computer, it is possible to send the content to either device. In this case, the content can be shared by synchronization among the devices.

Another aspect of the present invention is an information managing server that manages information used for user authentication when logging into a predetermined web site from the client terminal, comprising: a user identification information registering means for registering a user identification information of a user using the mobile device; an access information obtaining means for obtaining access information from the client terminal; a managing symbol publishing means for publishing a managing symbol; a recording means for recording an association between the managing symbol and the access information; a managing symbol sending means that sends the managing symbol published by the managing symbol publishing means, and displays the managing symbol on the display of the client terminal; an information obtaining means for obtaining, after the managing symbol is output, information embedded in the management symbol that is obtained based upon an image taken by a mobile device equipped with an image capturing function; an access specifying means for specifying the access upon reference to the association with the managing symbol based upon the information obtained by the information obtaining means; and a user identification information obtaining means for obtaining user identification information sent from the mobile device that captured the image of the managing symbol. The information managing server according to this aspect of the present invention manages information used for user authentication when logging in to a predetermined web site from the client terminal.

This aspect of the present information relates to user authentication upon log in from the client terminal to a certain web site. The user authentication is performed by obtaining previously registered user identification information from a mobile device other than the client terminal such as a personal computer.

The client terminal is preferably equipped with an access means to access the server managing the user identification information. The client terminal may also be equipped with an access means to access the server managing the web site. The mobile device is equipped with a communications means such as an electronic mail sending or receiving means for communicating with the server.

The access information obtained by the access information obtaining means is information identifying the access from the client terminal to the server managing the user authentication information. It may also be information identifying the access to the server managing the web site. Session information may also be used here.

The server can specify the client terminal accessing the server by obtaining the access information. Then the user can log in to the web site from the client terminal after user authentication.

The unique number of the mobile device is preferable to be used as user authentication information. The user of the mobile device registers the unique number in the server beforehand. The unique number may automatically be obtained from the memory of the mobile device so that the user does not need to register it manually.

The user authentication information may also be a user ID or password input by the user or a fingerprint or other information used for biometric authentication. It may also be an e-mail address of the user when sending and receiving of information is performed using the e-mail function of the mobile device.

The server according to this aspect of the present invention may further comprise: a user authentication information registering means for registering in association with the user identification information, a user authentication information for login to a web site; a user authentication information obtaining means for obtaining the user authentication information based on the user identification information; a user authentication requiring means for requiring user authentication for login the web site using the user authentication information; and a login information sending means for sending to the client terminal information for login to the web site.

The user authentication information is necessary for authentication when the user logs in to a certain web site, and may be a previously registered user ID or password. It may also be an encrypted bit string of a predetermined length.

The user identifying information and the user authentication information are preferably associated with one another and stored in a storage area accessible by the user, such as the user information table in the server.

The server according to this aspect of the present invention may also comprise: a user registering means for registering a user allowed to login to the web site; a user authentication means for authenticating a user based upon the user authentication information; and an authentication result sending means for sending to the web site result of the user authentication.

The user registering means may register in the user information table in the server whether each user is allowed to log in or not. The server may hold a list of users that are allowed to log in.

The user authentication means may authenticate the user based upon the user identification information.

The server managing the web site according to the present aspect of the invention may be managed by, but not limited to, the same server that manages information for user authentication or by the same management body that manages the server. The server managing the web site and the server managing the user authentication information may be separate servers or be managed by different management bodies.

These and additional features and advantages of the invention will be set forth in the detailed description that follows, and in part will be readily available to those skilled in the art from that description or recognized by practicing the invention as described herein.

It is to be understood that both the foregoing general description and the following detailed description are merely exemplary of the invention and are intended to provide an overview of framework for understanding the nature and character of the invention as it is claimed.

It is preferable that the elements of the present invention are embodied in a program or a combination of programs that runs on a general use computer. They may also be embodied in special purpose hardware, or a combination of software and hardware

### BRIEF DESCRIPTION OF THE DRAWINGS

The accompanying drawings, which are incorporated in and constitute a part of this specification, illustrate embodiments of the present invention and, together with the description, serve to explain the advantages and principles of the invention. In the drawings:

FIG. 1 is schematic illustration showing an example of a network configuration to which the present invention is applicable;

FIG. 2 is an illustration showing an example of a two-dimensional code of the present invention (FIG. 2A: Color two-dimensional code, FIG. 2B: Monochrome code);

FIG. 3 is an exemplary diagram showing an operation and construction of the information management method and system in an embodiment of the present invention;

FIG. 4 is an illustration showing an example of a name card in an embodiment of the present invention;

FIG. 5 a flowchart showing the first part of the operations in an embodiment of the present invention;

FIG. 6 is an illustration showing an example of the input screen in an embodiment of the present invention;

FIG. 7 is an illustration showing an example of the input screen in an embodiment of the present invention;

FIG. 8 shows an example of the database in an embodiment of the present invention;

FIG. 9 shows examples of action types and actions in an embodiment of the present invention;

FIG. 10 is a flowchart showing the second part of the operations in an embodiment of the present invention;

FIG. 11 is a flowchart showing the third part of the operations in an embodiment of the present invention;

FIG. 12 is an illustration showing an example of the action setting screen in an embodiment of the present invention;

FIG. 13 is an example of the user information table in an embodiment of the present invention;

FIG. 14 is a flowchart showing a part of the operations in an embodiment of the present invention;

FIG. 15 is an illustrative drawing of a mobile device capturing the image of a two-dimensional code in an embodiment of the present invention; and

FIG. 16 is a diagrammatic illustration showing the data conversion process from the database to a two-dimensional code in an embodiment of the present invention.

### DETAILED DESCRIPTION OF THE INVENTION

The best mode for carrying out the invention and variations thereof will be described below with reference to the drawings.

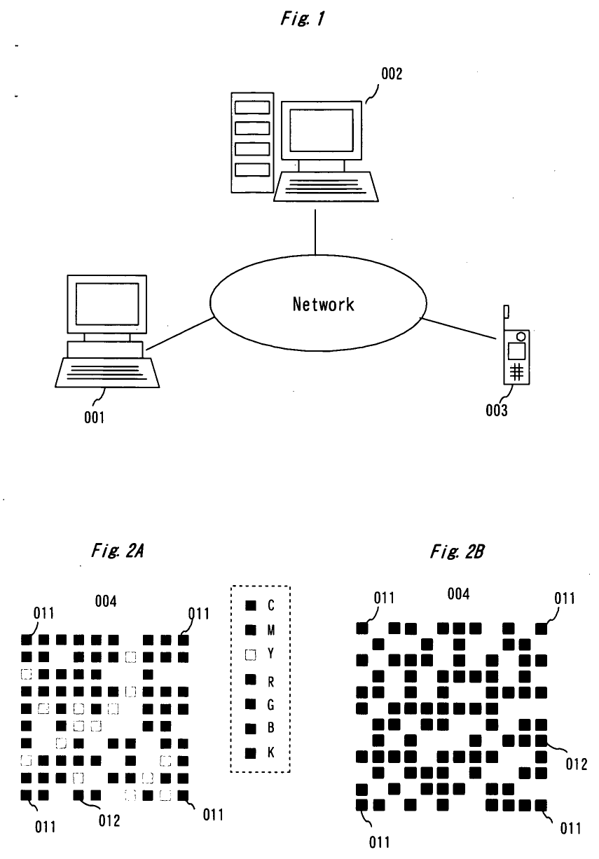

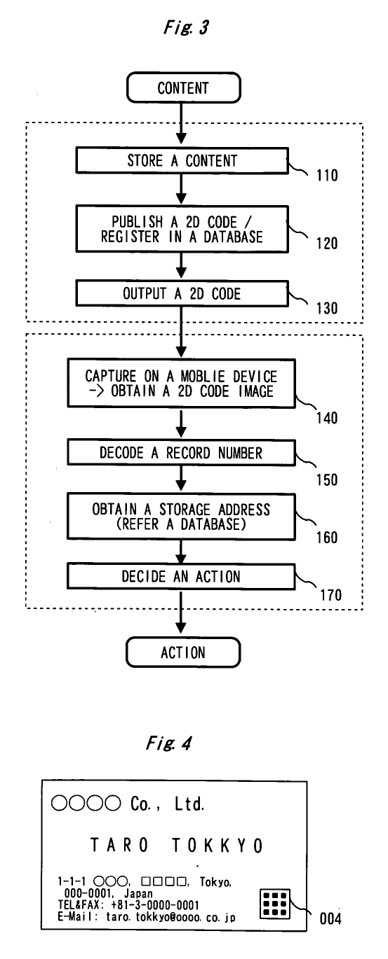

FIG. 1 is an exemplary block diagram showing an overview of the information management method and system according to an embodiment of the present invention. As shown in FIG. 1, a server 002, a registration client 001, and a mobile device 003 are all connected to a network. A two dimensional code as illustrated in FIG. 2 is used as a managing symbol in this embodiment.

The server 002 is cable of being accessed by the registration client 001 or the mobile device 003 any time. The registration client 001 and the mobile device 003 are both capable of accessing the server via the network. The mobile device 003 are further equipped with an image-capturing function. An example of the registration client 001 is a general-purpose personal computer, and an example of the mobile device 003 is a mobile phone with a camera.

As shown in FIG. 3, the information management method and system according to the present embodiment includes a content storing part 110, a two-dimensional code publishing part 120, a two-dimensional code output part 130, a two-dimensional code image obtaining part 140, a two-dimensional code decoding part 150, a storage address obtaining part 160 and an action deciding part 170.

The two-dimensional code publishing part 120 registers in a database the storage address of the content stored by the content storing part 110 and the action type to be performed on the content, and converts a number correspondent to the record in the database (record number) into a two-dimensional code to publish the two-dimensional code. The two-dimensional code output part 130 outputs the published two-dimensional code. The two-dimensional is output by printing it on a sheet of paper by a printing apparatus, or by displaying it on the display of a computer and other devices.

The two-dimensional code image obtaining part 140 is realized by an image-capturing function equipped on a mobile device or the like. The image of the output two-dimensional code is captured by a camera on a mobile phone or other mobile devices. The two-dimensional code decoding part 150 decodes the record number embedded in the two-dimensional code by analyzing the captured image. The storage address obtaining part 160 obtains the storage address of the content from the decoded record number, upon reference to the storage address field of the corresponding record in the database. The action deciding part 170 decides the action to be performed on the content upon reference to the action type field of the corresponding record in the database.

The specific values and methods mentioned below are what the inventors of the present invention found most preferable for this method through experiments. The values, however, may be in the ranges that are later mentioned. In the present embodiment, the record numbers of the database are converted one or more times to be represented by a two-dimensional code, as shown in FIG. 16.

Each record number of the database according to the present embodiment is represented as a 56-bit bit string. The number of records prepared in advance is preferably about 10 to the 16^{th} power (D101).

Redundant data of 8 bits is added to the record number to make it into a 64-bit bit string. Here, 8 bits of 0s are added at the head of the record number (D102).

The bit string is encrypted using a common key encryption system, DES (Data Encryption Standard). (D103)

An error-correcting code is added to the encrypted bit string using the Reed Solomon code. Each symbol of the error-correcting code consists of 4 bits (GF(2ˆ4)), 8 symbols out of the 12 symbols are parity symbols (12,4), making the bit string 192 bits (D104).

The error-correcting coded bit string is represented as a two-dimensional code based upon a display rule that is not made public (D105).

Here, a color two-dimensional code in which each cell is displayed by overlapping data marks colored in cyan, magenta and yellow are used as the two-dimensional code. The code consists of 10×10 cells, and the total number of cells including positioning symbols and such is 100.

In the present embodiment, there is a plurality of modes so that the display rule differs each time a two-dimensional code is published. The specified mode is recorded in the 16-bit mode information (D106), and is error-correcting coded (D107). It is then displayed in a different area of the two-dimensional code from that of the bit string. The 4-bit error-correcting code symbol added to the mode information consists of 4 cells of the same color component that are placed close together, in order for the error-correcting to be effective.

The number of records prepared in the database in advance may be anywhere from 10 to the 12th power to 10 to the 78th power. The record number may be a bit string consisting of 40 to 256 bits.

Redundant bits added to the record number may consist of 10 to 600 bits including the error-correcting code. The length of the error-correcting code may be 25 to 400% of the original bit string. In that case, the length of the bit string after the error-correcting code is added is from 50 to 900 bits.

When displaying the bit string in a color two-dimensional code, it is preferable for the cells of the data area to be from 16 to 300 cells. In case of a monochrome two-dimensional code, it may be from 50 to 600 cells.

The total number of cells including positioning symbols and such may be from 25 to 400 cells in a color two-dimensional code, and from 64 to 676 cells in a monochrome code.

It is preferable to keep the number of records of the database being used at the same time to less than ten percent of the total number of records, in order to prevent inappropriate access from a third person or a record specifying error.

In reusing a record, it is preferable to set a certain time period before the same record number is used again. In the present embodiment, the time period is set to a year for temporary use, and twenty years for ordinary use.

In another embodiment of the present invention, the user that provides the content by publishing the two-dimensional code (user A) and the user that captures the image of the two-dimensional code to use the content (user B) are two different users. In this case, the action that is performed when user B uses the content is specified beforehand by user A, the content provider.

For example, when an advertiser (user A) advertises a product, he/she prints the URL of the product web page on a flyer or such advertising materials in the form of a two-dimensional code. A customer (user B) captures an image of the two-dimensional code and accesses the web page to obtain specific information about the product or to purchase it.

Another example is user A printing his/her personal information such as name, address, telephone number and e-mail address on a name card as illustrated in FIG. 4 in the form of a two-dimensional code, and user B that receives the name card captures an image of the printed two-dimensional code to register the personal information of user A in an address book of his/her mobile device. When the two-dimensional code also includes a URL of user A's personal web page, user B may also access the web page.

User A may also publish a two-dimensional code correspondent to a plurality of image data for user B to have the plurality of image data displayed as an album display on his/her mobile device.

User A may also upload music data for user B to download and play it on his/her mobile device.

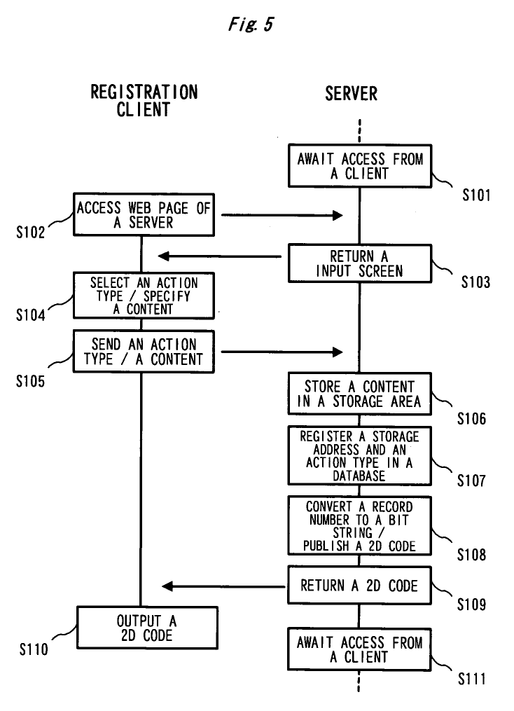

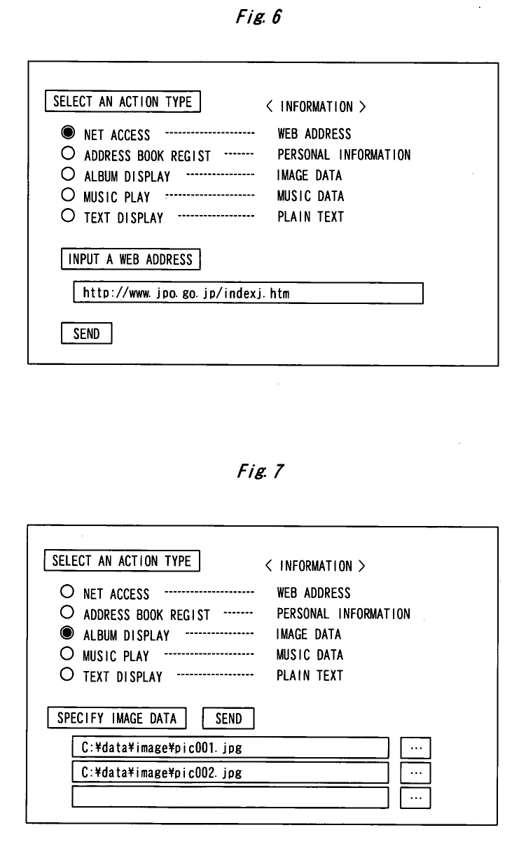

The process up to the publication of the two-dimensional code is described hereinafter referring to the flowchart shown in FIG. 5.
Step 101: The server 002 awaits access from registration client 001.
Step 102: User A accesses from a registration client 001 a specific URL or web page of the server.
Step 103: The server 002 returns input screens as illustrated in FIGS. 6 and 7 to the registration client 001 upon access.
Step 104: User A selects an action type on the input screen, specifies a content and clicks the “Send” button.
Step 105: The registration client 001 sends the selected action type and the specified content to the server.
Step 106: The server 002 receives the action type and the content, and stores them in a storage area. The storage address of the content is described as “/data/rec0001”, for example. When the content consists of a plurality of files, the plurality of files may be stored within the said directory.
Step 107: The storage address of the content (“/data/rec0001” in this case) is stored in a storage address field of a record in the database that is not being used. The action type of the content is stored in an action type field of the same record.
Step 108: The record number of the record that stores the storage address and the action type is converted to a bit string, and a two-dimensional code embedding the bit string is published.
Step 109: The published two-dimensional code is returned to the registration client 001.
Step 110: User A receives the two-dimensional code, and outputs it on a flyer, a name card or such.

Communication protocol between the registration client 001 and the server 002 is not limited to a particular protocol. The present embodiment uses the HTTP protocol, and Step 101 is realized by an HTTP daemon (HTTP service), and Steps 102 and 103 by a GET command of the HTTP protocol and a response to the command. The input screens as illustrated in FIGS. 6 and 7 may be described using the HTML (Hyper Text Transfer Protocol) language with Java Script and the like. Steps 105 and 109 is realized by a POST command and a response of the HTTP (Hyper Text Transfer Protocol) protocol, and Steps 106 to 108 by a CGI program or a Servlet on the server side.

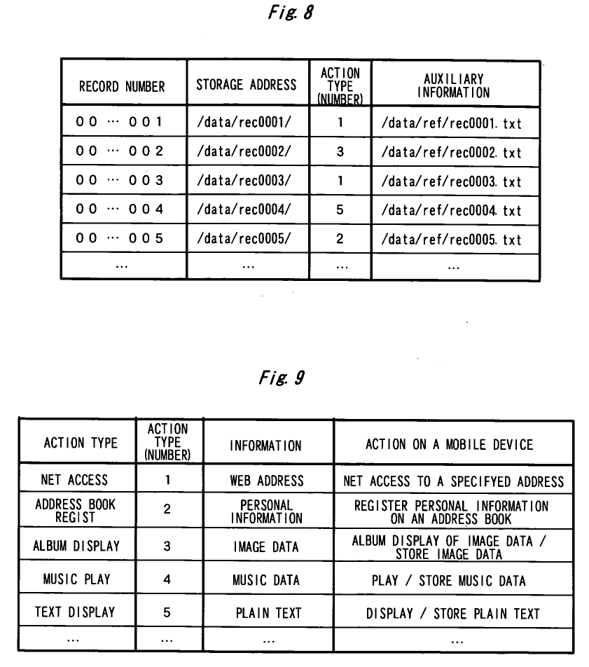

An example of the database is illustrated in FIG. 8. A number (record number) is allocated to each number, and the database includes a storage address field and an action type field. The database according to the present embodiment further includes an auxiliary information field.

A record number is a number for specifying the record, and is represented by the two-dimensional code. The record number shown in FIG. 8 is a decimal number for illustrative purposes, but it is preferable that the record number is bit string consisting of binary numbers.

The storage address field stores the storage address (directory) of the storage that stores the content.

The action type field stores an action type that decides how to process the content. Examples of action types and the actions are shown in FIG. 9.

The auxiliary information field stores information other than the action type such as registration date and period of validity of the content. In the present embodiment, the auxiliary information is written in a text file and stored in the storage. The storage address of the text file is stored in the auxiliary information field.

The input screen illustrated in FIGS. 6 and 7 displays an area for specifying the content, a button for selecting the action type and a “Send” button. When the user selects an action type, the area for inputting or specifying the content is displayed according to the selected action type. For example, when “Net Access” is selected as the action type, a web address input field is displayed. When “Album Display” is selected as the action type, an image data specifying field is displayed as shown in FIG. 7.

FIG. 6 shows an example where the content is a web address (text data), and the web address is input directly on the input screen. The user first selects “Net Access”, types the web address in the content specifying field, and clicks the “Send” button to send the selected action type (net access) and the content to the server.

FIG. 7 shows an example where the content consists of a plurality of image data. The user selects a storage folder within the registration client 001 in the “Specify Image Data” field. Here, the user first selects “Album Display”, specifies the storage folder, and clicks the “Send” button. Then all of the specified image data are taken out from the storage folder and sent to the server with its action type.

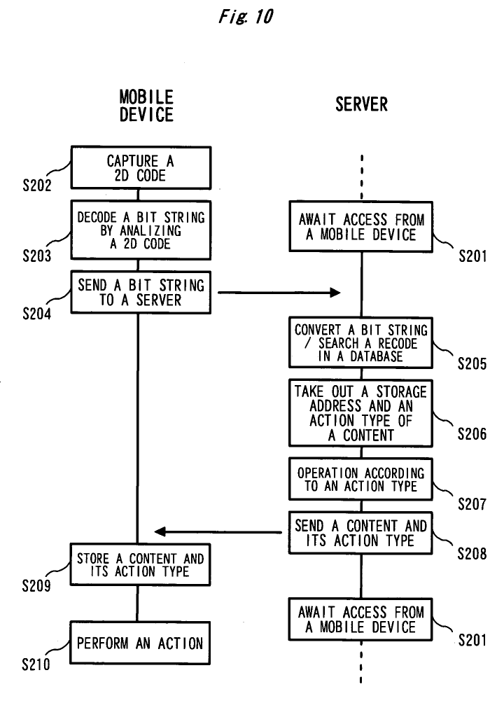

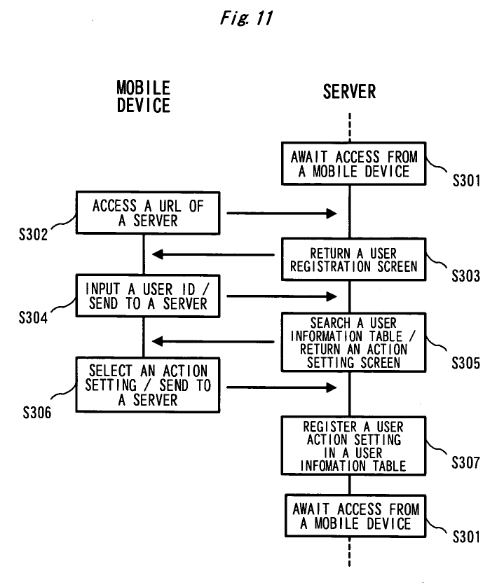

The process from reading of the two-dimensional code by the mobile device up to the deciding of the action to be performed to the content is described hereinafter referring to the flowchart shown in FIG. 10.
Step 201: The server 002 awaits access from mobile device 003.
Step 202: User B captures an image of the two-dimensional code output in Step 110 with a camera function equipped on a mobile device.
Step 203: The two-dimensional code is analyzed based upon the captured image to decode the bit string embedded in the two-dimensional code.
Step 204: The decoded bit string is sent to the server 002.
Step 205: The server 002 receives the bit string, converts the bit string to a record number, and searches the corresponding record in the database.
Step 206: The storage address and the action type of the content are taken out from the storage address field and the action type field of the record, respectively.
Step 207: An operation according to the action type are performed on the content.
Step 208: The content and its action type are sent to the mobile device.
Step 209: The received content and action type are stored in the mobile device.
Step 210: The action is performed on the content on the mobile device.

In Step 204, information regarding the mobile device is sent to the server along with the bit string. Information regarding the mobile device may be the display size of the mobile device or the type of audio CODEC the mobile device can play. The information is used by the server to convert the content.

In Step 207, the operation is performed on the server side. For example, when the action type is “Album Display”, the server converts the image data so that they are fit to be displayed on the mobile device, by referring to the information obtained in Step 204. When the action type is “Audio Playback”, the server converts the audio data to the audio CODEC that can be played on the mobile device.

In Step 210, the action is performed on the mobile device side. For example, when the action type is “Net Access”, the mobile device accesses an URL. When the action type is “Register in Address Book”, the obtained personal information is registered in the address book in the mobile device. When the action type is “Album Display”, the obtained plurality of image data is album displayed using an application in the mobile device.

Steps 202 to 204 and Steps 209, 210 are performed by running an application on the mobile device. The URL of the server is embedded beforehand in the application.

The application sends the information regarding the mobile device to the server 002 in Step 204. The information may be input by the user or may automatically be obtained by the application. The application is described in a program language correspondent to each mobile device.

Communication protocol between the mobile device 003 and the server 002 is not limited to a particular protocol. The present embodiment uses the HTTP protocol, and Steps 204 and 208 are realized by a POST command and a response of the HTTP protocol, and Steps 205 to 207 by a CGI (Common Gateway Interface) program or a Servlet on the server side.

The auxiliary information field of the database stores an address of a file that records time information. Time information includes the date of registration, the period of validity and such. The record is freed and reused after a certain period of time, the period of validity, has passed. The date on which the record is to be freed may also be recorded as time information.

The period of validity is managed by a program on the server accessing the database periodically. The database is accessed in intervals of the smallest unit of time stored as time information. For example, when time information consists of year/month/date, the smallest unit of time is a day, therefore the database is accessed everyday to inspect if the period of validity has passed.

Used records and unused records are managed by a list of unused records stored in the server. When freeing a record the period of validity of which has lapsed, the record number is added to the list. When a two-dimensional code is published, the correspondent record number is deleted from the list.

The server accessed by the client terminal 001, the server storing the contents, the server storing the database and the server accessed by the mobile device 003 as described in the present embodiment may be realized as one server or as a plurality of servers.

The mobile device capturing the image data of the two-dimensional code may also be a personal computer terminal and other similar devices. In that case, a scanner, a digital camera or other such input apparatus is used to obtain the image data in Step 202.

In another embodiment of the present invention, the user that provides the content by publishing the two-dimensional code (user A) and the user that takes the image of the two-dimensional code to use the content (user B) are also two different users as in the previously described embodiment. In this case, however, the action that is performed when user B uses the content is specified beforehand by user B him/herself. User B registers as a user and sets an action beforehand.

For example, when the content that user B receives is a URL (text data), the user can access the URL from the mobile device as described in the previous embodiment and also store the URL in a personal storage area on the network and bookmark it in his/her personal web page.

Here, a personal web page is a web page customized by each user according to his/her objectives. The personal web page is provided with a bookmark function that shows a list of web page addresses selected by the user.

When the content that user B receives is an image data, it is displayed on the mobile device as described in the previous embodiment and also stored in a personal storage area on the network.

The process up to the publication of the two-dimensional code is similar to that described in the previous embodiment as Steps 101 to 110, and are not described here.

The process of registration of action setting by the user in a user information table is described hereinafter referring to the flowchart shown in FIG. 11. It is preferred that the action is set before the two-dimensional code is published. Once the action setting is registered, it is not necessary to set the action every time.
Step 301: The server 002 awaits access from mobile device 003.
Step 302: User B accesses the URL of the server 002 from the mobile device 003.
Step 303: The server returns a user registration screen to the mobile device 003 upon access from the mobile device 003.
Step 304: User B inputs his/her user ID and password in the user registration screen, and they are sent to the server. Unique information (serial number) of the mobile device 003 is also sent at the same time. By sending the unique information upon access, s the user does not need to input the user ID and password every time. The user ID, password, and unique information of the mobile device are referred to as user identification information hereinafter.
Step 305: The server, upon receipt of the user identification information, searches the user information table and returns an action setting screen of the user. An example of the action setting screen is illustrated in FIG. 12. When the user is not yet registered in the user information table, the user ID and password is registered here.
Step 306: User B selects an action setting, which is sent to the server.
Step 307: The server, upon receipt of the user action setting, registers it in the user information table.

The mobile device 003 in the above described Steps 301 to 304 may also be a personal computer or any other device that can access a web page via network.

FIG. 12 shows an example of the input screen for setting the user action in Step 306. An example of an action that may be set by a user is registration of the content in a personal web page. By storing the content in a personal storage area on the network, an URL can be viewed as a bookmark, a personal information as an address book, an image as a web album. When the content is registered on the personal web page of the user, the user can browse the content anytime anywhere using a device that can access the web, such as a personal computer or a mobile device.

The address of the user's personal web page, user ID, password necessary for accessing the personal web page are recorded in the user information table beforehand and referred to.

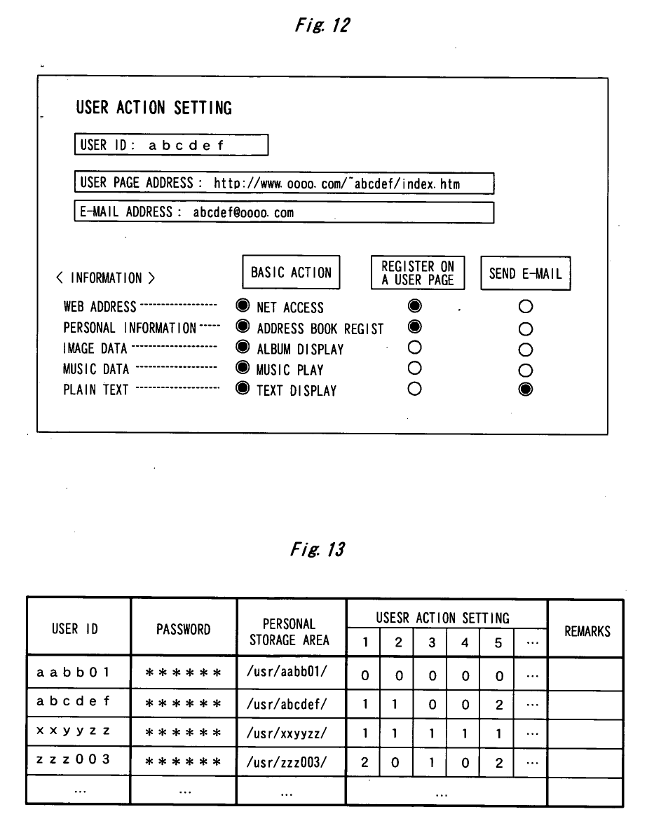

An example of the user information table for registering the user action setting in Step 307 is shown in FIG. 13. The user information table includes fields for recording user ID, password, personal storage area, user action setting and remarks. The user action setting field has a column for each type of digital information. In the table shown in FIG. 13, “1” signifies web address, “2” signifies personal information, “3” signifies image data, “4” signifies music data and “5” signifies plain text data.

In the user action setting field, an action is set to the content by allocating a number to each action setting. When “0” is set, only a basic operation is performed. When “1” is set, the basic operation and registration to the user's personal web page are performed. When “2” is set, the basic operation and sending of an e-mail to a specified e-mail address are performed. Other combinations of operations are also possible by allocating a number for the combination. When “9” is set, no operation is performed.

The user ID field and the password field store an ID for identifying the user and a password, respectively. An encryption of the password or a hash value of the password is stored in the password field. The personal storage area field stores the address of the user's personal web page or the directory within the storage if it is within the same server. The remarks field holds the unique information of the mobile device, the period of validity for the user, and other information.

Communication protocol between the registration client 001 and the server 002 is not limited to a particular protocol. The present embodiment uses the HTTP protocol, and Step 301 is realized by an HTTP daemon (HTTP service), and Steps 302 and 303 by a GET command of the HTTP protocol and a response to the command. The input screen as illustrated in FIG. 12 may be described using the HTML language with Java Script and such. Steps 304 and 305, Steps 306 and returning of the “registration complete” screen in Steps 307 and beyond are realized by a POST command and a response of the HTTP protocol, and Steps 305 and 307 by a CGI program or a Servlet on the server side.

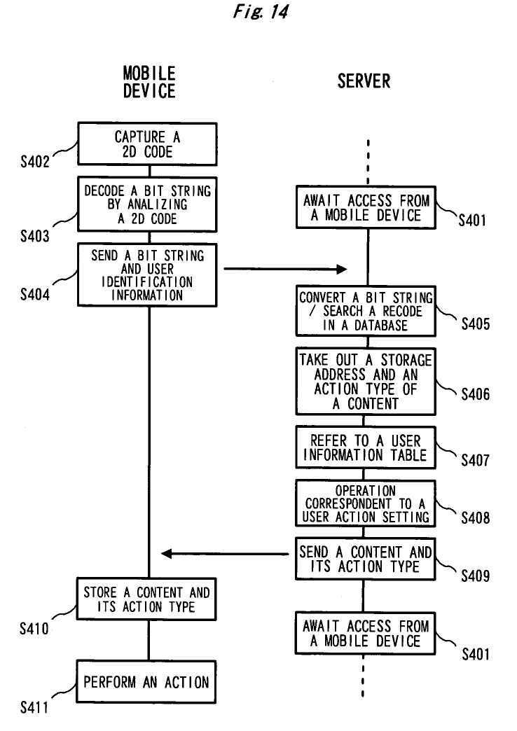

The process from reading of the two-dimensional code by the mobile device up to the deciding of the action to be performed to the content is described hereinafter referring to the flowchart shown in FIG. 14. Steps that are similar to those shown in FIG. 10 are not described herein.
Step 401: Refer to Step 201.
Step 402: Refer to Step 202.
Step 403: Refer to Step 203.
Step 404: The decoded bit string and user identification information are sent to the server. Here, the user identification information includes user ID and password registered in Step 304. When the unique information of the mobile device is registered in Step 304, user B does not need to input user ID and password.
Step 405: Refer to Step 205.
Step 406: Refer to Step 206.
Step 407: The user is specified by referring to the user information table using the user identification information received in Step 405. When the password does not match, an error is returned to the mobile device and prompts the user to input authentication information again.
Step 408: An operation correspondent to the user action setting is performed on the content.
Step 409: Refer to Step 208.
Step 410: Refer to Step 209.
Step 411: Refer to Step 210.

In Step 408, the operation to be performed on the content is decided by referring to the user action setting field of the user information table.

For example, in the user information table shown in FIG. 13, a user setting number “1” is set for digital information type “1” (web address) for user ID “abcdef”. Therefore, when the content is a web address, a basic operation, net access, is performed in combination of bookmark registration in the user's personal web page. For bookmark registration, a file describing the URL is added to the bookmark directory (/usr/abcdef/bookmark/) of the user's personal storage area.

A user setting number “1” is also set for digital information type “2” (personal information) for user ID “abcdef”. Therefore, when the content is personal information, a basic operation, registration of the personal information in an address book of the mobile device, is performed in combination with registration in an address book of the user's personal web page. The personal information is added to the address book file (usr/abcdef/address.txt) of the user's personal storage area.

A user setting number “1” is set for digital information type “3” (image data) for user ID “zzz003”. Therefore, when the content is an image data, a basic operation, album displaying on the mobile device, is performed in combination with registration in an album of the user's personal web page. The image data is added to the image data storage area (usr/zzz003/image/) of the user's personal storage area.

In the present embodiment, a user may select as an action to have the content sent by e-mail from the content. In that case, user B specifies the e-mail address on the input screen shown in FIG. 12 in
Step 306. Also, in Step 307, an action setting number (“2” in the example in this embodiment) that includes an e-mail sending operation is set in the user action setting field of the user information table. The e-mail address is recorded in an e-mail address column within the remarks field.

For example, in the user information table shown in FIG. 13, a user setting number “2” is set for digital information type “1” (web address) for user ID “zzz003”. Therefore, when the content is a web address, an e-mail including an URL or an e-mail with a text file that includes the URL attached is sent.

The user's personal web page described in the present embodiment may be managed by the same server that stores the database or by the same management body that manages the server. It may also be a general page for personal use (My Page) provided by another network service provider. The parts similar to those in previously described embodiments are not explained here in detail.

In another embodiment of the present invention, the user that provides the content by publishing the two-dimensional code (user A) and the user that uses the content (user B) are the same user. In this embodiment, a user can easily transfer a content within his/her personal computer to his/her mobile device to share the content among devices.

For example, the user transfers an image data stored in the personal computer to the mobile device so that the image data can be viewed anytime anywhere on the mobile device. It is also possible to share music data and other data generated by an application in the personal computer with the mobile device.

More specifically, the content stored in the personal computer is uploaded to a server from the personal computer, and the server returns a two-dimensional code.

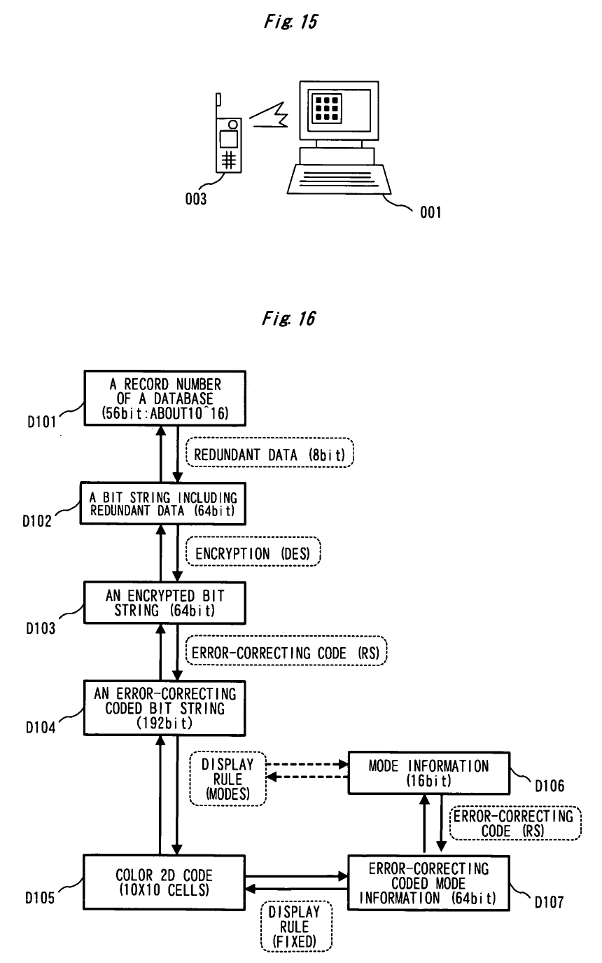

Then the two-dimensional code is both displayed on the personal computer and captured by a camera function of the mobile device, as illustrated in FIG. 15.

Image data of the two-dimensional code is sent from the mobile device to the server. The image data may be sent using the e-mail function of the mobile device.

The image data of the two-dimensional code is analyzed to specify the content uploaded from the personal computer.

The specified content is sent to the mobile device. The content is thus transferred from the personal computer to the mobile device via the server.

The content may be uploaded after the two-dimensional code is displayed on the personal computer. In this case, the record to be used is first decided to publish the two-dimensional code, and the content is registered correspondent to the record.

In the present embodiment, receiving and sending of the image of the two-dimensional code and the content is performed using the mail function of the mobile device. The mobile device captures the image of the two-dimensional code with its camera function, and attaches the image to the e-mail sent to the e-mail address of the server.

The server obtains the image of the two-dimensional code and the e-mail address of the sender of the mail from the received e-mail. It is preferable that the server has a filtering function to delete inappropriate e-mail. E-mail sent from a sender other than mobile telecommunications companies may be deleted, for example. E-mails with an attached image file the format or size of which is inappropriate may also be deleted. Appropriate format and size may be JPEG and 10 kilobytes to 1 megabyte, respectively.

Then the obtained image of the two-dimensional code is analyzed to specify the content and to perform an operation according to the action type. When sending the content to the mobile device, it is sent to the e-mail address of the sender.

The title of the e-mail sent in return from the server may correspond to the action type, so that it is easier for the user to find a particular mail from the received mail list. The title may also include the digital information type.

Here, the server is equipped with a mail server function such as SMTP (Simple Mail Transfer Protocol) and POP (Post Office Protocol). The parts similar to those in previously described embodiments are not explained here in detail.

In another embodiment of the present invention, the user that provides the content to publish the two-dimensional code (user A) and the user that uses the content (user B) are the same user as in the previously described embodiment. In this embodiment, a user can easily transfer a content within his/her mobile device to his/her personal computer to share the content among devices and to use it or to make a backup copy.

More specifically, the user operates the personal computer to access the server, and the server returns the two-dimensional code. The server, at that time, obtains access identification information that identifies the access from the personal computer and registers it in the database.

Then the two-dimensional code is both displayed on the personal computer and captured by a camera function of the mobile device.

Image data of the two-dimensional code and the content stored within the mobile device is uploaded to the server. The image data may be uploaded using the e-mail function of the mobile device.

The image data of the two-dimensional code is analyzed to specify the personal computer accessing the server by referring to the access identification information in the database.

The content uploaded from the mobile device is sent to the specified personal computer. The content is thus transferred from the mobile device to the personal computer via the server. The parts similar to those in previously described embodiments are not explained here in detail.

In another embodiment of the present invention, the user that provides the content to publish the two-dimensional code (user A) and the user that uses the content (user B) are the same user as in the previously described embodiments. In this embodiment, a user can easily synchronize and share the content between his/her mobile device and his/her personal computer.

For example, an address book or a schedule book stored in the personal computer or the mobile device is synchronized so that it is always updated in both devices.

More specifically, the user operates the personal computer to access the server, and the server returns the two-dimensional code. The server, at that time, obtains access identification information that identifies the access from the personal computer and registers it in the database.

Then the two-dimensional code is both displayed on the personal computer and captured by a camera function of the mobile device.

Image data of the two-dimensional code and the content stored within the mobile device is uploaded to the server. The server also obtains at that time access identification information that identifies the access from the mobile device.

The image data of the two-dimensional code is analyzed to specify the personal computer accessing the server referring to the access identification information in the database.

The server compares each of the contents uploaded from the personal computer and the mobile device, and specifies the content that has been updated more recently.

Then the newer content is sent to the terminal that stores the older content to replace the older content.

The content is thus synchronized between the personal computer and the mobile device via the server.

It is also possible to just upload the date that the content was updated instead of uploading the content itself. In that case, the dates of update are compared to upload just the content with a newer update.

The parts similar to those in previously described embodiments are not explained here in detail.

In another embodiment of the present invention, the user operating the personal computer and the user possessing the mobile user are the same user. In the present embodiment, the user can log in to a web site from a personal computer without inputting user authentication information.

For example, the user can access a web site that requires user authentication information from the personal computer by capturing the image of the two-dimensional code displayed on the personal computer with a mobile device possessed by the user. This way, the user does not need to type his/her ID and password to log in, and security of the system is enhanced.

In the below description of the present embodiment, “server” refers to the server managing the two-dimensional code, and “web site” refers to the web site to which a user wishes to log in. Both the authentication information for logging in to the web site and the unique information of the mobile device possessed by the user are registered in the server beforehand.

The registration of the authentication information may be realized by setting up a web page for user registration to which a user accesses to input the URL and the authentication information of the website. The unique information of the mobile device may also be registered by accessing the registration web page from the mobile device. Unique information of the mobile device may be its individual recognition number or serial number.

Registration of authentication information is not necessarily required when both the server and the web site are managed by the same management body, or when the web site consists of information that does not require proper authentication. The user may register in a plurality of web sites.

Specific procedures of the present embodiment are described hereinafter.

First, the user accesses the server from a personal computer and selects a web site from a plurality of web sites registered in the server. The selection process is not necessarily required when only one web site is registered.

The server publishes a two-dimensional code representing unique information and returns the code to the personal computer. The server then associates the two-dimensional code, the information regarding the access from the personal computer (session information) and the information regarding the selected web site and records in the database.

The access from the personal computer to the server needs to be maintained while the server makes the above association. This can be achieved by having the personal computer automatically accessing the server at certain time intervals, for example. The automatic access can be achieved by including a Meta tag in the HTML of the web site.

The two-dimensional code is displayed on the personal computer. The user captures an image of the two-dimensional code with a camera equipped on a mobile device, and sends the image and the unique information of the mobile device to the server.

The server obtains session information between the personal computer and server and the URL of the web site from the two-dimensional code, and authentication information from the unique information of the mobile device.

Then, the server uses the authentication information to access the web site, and redirects to the personal computer the URL of the web site returned as a result of the access. The redirection may be realized by specifying the page accessed by the personal computer at time intervals from the session information, and rewriting the Meta tag of the page.

In the above description, the personal computer first accesses the server. It is also possible to have the personal computer accessing the web site. In that case, the accessed web site mains the session with the personal computer and makes a request to the server to publish the two-dimensional code.

The server publishes the two-dimensional code and records it in the database in association with the web site that made the request. The server sends the published two-dimensional code to the web site, and the code is displayed on the personal computer via the web site.

Then the server obtains the web site information from the two-dimensional code, and the authentication information from the unique information of the mobile device, and sends the authentication information to the web site.

The web site, upon receipt of the authentication information, performs an authentication, and returns a page of the web site to the personal computer maintaining the session. It is also possible to perform the authentication in the server and send only the user information or the result of the authentication to the web site. The authentication performed in the server may just be specification of the registered user from the received unique information of the mobile device, or further user authentication may be performed between the mobile device and the server.

The parts similar to those in previously described embodiments are not explained here in detail.

Numerous modifications and alternative embodiments of the invention will be apparent to those skilled in the art in view of the foregoing description. This description, accordingly, is to be construed as illustrative only and is for the purpose of teaching those skilled in the art the best mode for carrying out the invention. Details of the structure may vary substantially without departing from the spirit of the invention, and exclusive use of all modifications that come within the scope of the appended claims is reserved. It is intended that the invention be limited only to the extent required by the appended claims and the applicable rules of law.

What is claimed is:

1. An information management method for managing electronic content within a server connected to a network, comprising the steps of:
storing the electronic content in a storage area accessible from the server;
storing an association between a bit string assigned to each electronic content and the storage address of the electronic content in a storage area accessible from the server;
publishing a managing symbol representing the bit string in the server;
obtaining the bit string decoded based upon the managing symbol captured by a client terminal; and
specifying the electronic content correspondent to the decoded bit string by referring to the association with the electronic content.

2. The information management method of claim 1, wherein:
the storage address of the electronic content is recorded in a database stored in a storage area accessible from the server;
the bit string assigned to each electronic content corresponds to a record number of the database;
the bit string correspondent to a record number includes redundant data;
the managing symbol is a two-dimensional code representing the bit string by displaying a data mark within each of a plurality of cells placed on a flat surface; and
the bit string including redundant data is represented as a two-dimensional code using a rule that is not made public.

3. The information management method of claim 2, wherein:
the redundant data included in the bit string is an error-correcting code;
coding and decoding using the error-correcting code are performed in the server; and
the rule for displaying the cells of the two-dimensional code is not made public.

4. The information management method of claim 2, wherein:
the database includes a control field for recording information to control the period or number of use of the record number;
the usage of the record number that has exceeded its predetermined period or number limit of use is suspended; and
the suspension period of the record number is managed so as to resume usage of the record number after a predetermined time has lapsed.

5. An information management method for managing electronic content within a server connected to a network, comprising the steps of:
storing the electronic content in a storage area accessible from the server;
setting an operation to the electronic content by selecting from a plurality of operational modes provided for each digital content type;
publishing a managing symbol associated with the electronic content in the server;
specifying the electronic content associated with the managing symbol captured by a client terminal;
deciding the operation to be performed to the electronic content upon reference to the set operation; and
performing the operation via a program stored in the server.

6. The information management method according to claim 5, wherein:
the association between the managing symbol and the electronic content is recorded in a database stored in a storage area accessible from the server;
the database includes an operation type field for setting an operation to the electronic content; and
the operation performed on the electronic content is decided upon reference to the operation type field.

7. The information management method according to claim 5, wherein:
the electronic content consists of at least one image data;
the server obtains information regarding a display screen of a client terminal;
the image data is converted according to the information regarding the display screen; and
the converted image data is sent to the client terminal from the server and then displayed on the display screen of the client terminal.

8. The information management method according to claim 5, wherein:
a user information table recording information regarding a user that uses the client terminal is stored in a storage area accessible from the server;
the operation to be performed on each electronic content is set based upon the operation type selected by the user and recorded in the user information table;
the user using the client terminal is specified by the server obtaining information from the client terminal; and
the operation to be performed on the electronic content is decided upon reference to the user information table.

9. The information management method according to claim 5, wherein:
a user information table recording information regarding a user that uses the client terminal is stored in a storage area accessible from the server;
the user information table records information for specifying an address of a personal storage area of the user;
the user using the client terminal is specified by the server obtaining information from the client terminal; and
the electronic content stored in the storage area is stored in the personal storage area of the specified user.

10. An information management server that manages sending and receiving of electronic content via the server among a plurality of client terminals capable of being connected to a network, wherein at least one of the client terminals is a mobile device equipped with an image capturing function, comprising:
a content receiving means for receiving an electronic content from a client terminal;
an instructing means for instructing the received electronic content to be stored in a storage area accessible from the server;
a managing symbol publishing means for publishing a managing symbol;
an information obtaining means for obtaining, after the managing symbol is output, information embedded in the management symbol that is obtained based upon an image taken by a mobile device equipped with an image capturing function; and
a content sending means for sending the stored electronic content to the client terminal.

11. The information managing server according to claim 10, further comprising:
a recording means for recording an association between the managing symbol and the electronic content;
a content specifying means for specifying the electronic content upon reference to the association based upon the information obtained by the information obtaining means;
an operation deciding means for deciding an operation according to the type of digital information consisting the specified electronic content; and
a content processing means for processing the electronic content according to the operation decided by the operation deciding means.

12. The information managing server according to claim 10, further comprising:
a recording means for recording a association between the managing symbol and the electronic content;
an electronic mail receiving means for receiving an image of the managing symbol sent using an electronic mail function of the mobile device;
a managing symbol decoding means for decoding information embedded in the managing symbol based upon the received image;
a content specifying means for specifying the content upon reference to the association with the managing symbol based upon the information obtained by the information obtaining means; and
an electronic mail sending means for sending an electronic mail to the mobile device, the electronic mail including either the content specified by the content specifying means or an storage address of the content.

13. The information managing server according to claim 10, further comprising:
a recording means for recording an association between the managing symbol and the electronic content;
a managing symbol sending means that sends the managing symbol published by the managing symbol publishing means, and displays the managing symbol on the display of the client terminal;
a content specifying means for specifying the content upon reference to the association with the managing symbol based upon the information obtained by the information obtaining means; and
a content sending means for sending the specified content to the mobile device.

14. The information managing server according to claim 10, further comprising:
an access identifying means for identifying an access from the client terminal;
a recording means for recording an association between the managing symbol and the access;
a managing symbol sending means that sends the managing symbol published by the managing symbol publishing means, and displays the managing symbol on the display of the client terminal;
an access specifying means for specifying the access upon reference to the association with the managing symbol based upon the information obtained by the information obtaining means; and
a content sending means for sending the specified content to the client terminal that accessed the server.

15. An information managing server that manages information used for user authentication when logging into a predetermined web site from the client terminal, comprising:
a user identification information registering means for registering a user identification information of a user using the mobile device;
an access information obtaining means for obtaining access information from the client terminal;
a managing symbol publishing means for publishing a managing symbol;
a recording means for recording an association between the managing symbol and the access information;
a managing symbol sending means that sends the managing symbol published by the managing symbol publishing means, and displays the managing symbol on the display of the client terminal;
an information obtaining means for obtaining, after the managing symbol is output, information embedded in the management symbol that is obtained based upon an image taken by a mobile device equipped with an image capturing function;
an access specifying means for specifying the access upon reference to the association with the managing symbol based upon the information obtained by the information obtaining means; and
a user identification information obtaining means for obtaining user identification information sent from the mobile device that captured the image of the managing symbol.
